(19) United States
(12) Patent Application Publication
(10) Pub. No.: US 2023/0314913 A1
(43) Pub. Date: Oct. 5, 2023

(54) LENS APPARATUS, CONTROL METHOD, AND STORAGE MEDIUM

(71) Applicant: CANON KABUSHIKI KAISHA, Tokyo (JP)

(72) Inventor: TAKESHI YONEZAWA, Tochigi (JP)

(21) Appl. No.: 18/193,469

(22) Filed: Mar. 30, 2023

(30) Foreign Application Priority Data
Apr. 4, 2022 (JP) 2022-062553

(51) Int. Cl. G03B 17/14; G02B 7/00; H04N 23/617; H04N 23/80

(52) U.S. Cl. CPC G03B 17/14; G02B 7/005; H04N 23/617; H04N 23/80

(57) ABSTRACT

A lens apparatus in which first and second operation units are replaceable includes a member movable by an operation of the first or second operation unit, a detector configured to detect a position of the member, a memory configured to store first detected values output from the detector for a plurality of indices of the first operation unit, and second detected values output from the detector for a plurality of indices of the second operation unit, an acquiring unit configured to acquire a characteristic of the lens apparatus based on the position of the member, and a specifying unit configured to specify the first or second operation unit to be used. The acquiring unit acquires the characteristic based on the first detected values in a case where the first operation unit is specified, and otherwise based on the second detected values.

### BACKGROUND

### Technical Field

The aspect of the embodiments relates to a lens apparatus, a control method, and a storage medium.

### Description of the Related Art

Japanese Patent Laid-Open No. (JP) 4-125508 discloses a lens apparatus with improved position detecting accuracy by correcting the nonlinearity of the output voltage caused by the nonlinearity of a resistance value of a resistor by applying a voltage to at least one point other than both ends of the resistor.

One conceivable method is to correct a detected value based on a plurality of positions (actual positions) in a movable range of an optical member and a detected value (output) of a position detector. In some conventional lens apparatuses, a plurality of operation rings are replaceable. For example, in some conventional lens apparatuses, for an object distance, an operation ring with a metric scale (in units of meters) and an operation ring with an imperial scale (in units of feet and inches) can be replaceable. In other conventional lens apparatuses, some of the optical units in the imaging optical system are replaceable. In this case, a zoom operation ring, an aperture operation ring, etc. are replaced. with an operation ring according to an optical characteristic that changes due to the replacement.

In a case where the operation ring is replaced, the positions of scale lines (also referred to as index lines or indices hereinafter) on the operation ring change. Thus, a detected value (position information) of a position detector corrected for indices on a specific operation ring is less accurate than a detected value of a position detector for indices on another operation ring.

### SUMMARY

In a lens apparatus according to one aspect of the embodiments, a first operation unit and a second operation unit are replaceable with each other. The lens apparatus includes a member movable by an operation of the first operation unit or the second operation unit, a detector configured to detect a position of the member, a memory configured to store a plurality of first detected values each of which is output from the detector for a plurality of indices of the first operation unit, and a plurality of second detected values each of which is output from the detector for a plurality of indices of the second operation unit, and a processor. The processor is configured to function as an acquiring unit configured to acquire a characteristic of the lens apparatus based on the position of the member, and a specifying unit configured to specify one of the first operation unit and the second operation unit to be used. The acquiring unit acquires the characteristic at least based on the plurality of first detected values in a case where the specifying unit specifies the first operation unit. The acquiring unit acquires the characteristic at least based on the plurality of second detected values in a case where the specifying unit specifies the second operation unit.

In a lens apparatus, a first operation unit and a second operation unit are replaceable with each other and each of them is configured to move a member. A method of the lens apparatus according to another aspect of the embodiments includes specifying one of the first operation unit and the second operation unit to be used, and acquiring a characteristic of the lens apparatus based on a plurality of first detected values each of which is output for at least a plurality of indices of the first operation unit by a detector configured to detect a position of the member in a case where the specifying specifies the first operation unit, and based on a plurality of second detected values each of which is output for at least a plurality of indices of the second operation unit by the detector in a case where the specifying specifies the second operation unit. A non-transitory computer-readable storage medium storing a program that causes a computer to execute the above method also constitutes another aspect of the aspect of the embodiments.

### BRIEF DESCRIPTION OF THE DRAWINGS

FIG. 1 is a block diagram of an imaging system according to a first embodiment.

FIGS. 2A and 2B explain F-operation units in the first embodiment.

FIGS. 3A and 3B explain optical information tables in the first embodiment.

FIGS. 4A and 4B explain detected value tables in the first embodiment.

FIG. 5 is a flowchart of adjustment processing according to the first embodiment.

FIG. 6 explains calculation processing according to the first embodiment.

FIG. 7 explains calculation processing according to the first embodiment.

FIGS. 8A and 8B explain optical information tables in a variation of the first embodiment.

FIGS. 9A to 9D explain optical information tables in the variation of the first embodiment.

FIG. 10 explains calculation processing according to another variation of the first embodiment.

FIG. 11 is a block diagram of an imaging system according to a second embodiment.

FIGS. 12A and 12B explain Z-operation units in the second embodiment.

FIGS. 13A to 13D explain optical information tables for zooming in the second embodiment.

FIGS. 14A and 14B explain detected value tables for zooming in the second embodiment.

FIG. 15 is a flowchart of adjustment processing according to the second embodiment.

FIG. 16 is a flowchart of selection processing according to the second embodiment.

FIG. 17 explains calculation processing according to the second embodiment.

FIGS. 18A to 18D explain I-operation units in the second embodiment.

FIGS. 19A to 19G explain optical information tables for an aperture stop according to the second embodiment.

### DESCRIPTION OF THE EMBODIMENTS

Further features of the disclosure will become apparent from the following description of exemplary embodiments with reference to the attached drawings. In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or program that, when executed by the CPU, cause the CPU to perform operations corresponding to units or functions. In the hardware context, the term “unit” refers to a hardware element, a circuit, an assembly, a physical structure, a system, a module, or a subsystem. It may include mechanical, optical, or electrical components, or any combination of them. It may include active (e.g., transistors) or passive (e.g., capacitor) components. It may include semiconductor devices having a substrate and other layers of materials having various concentrations of conductivity. It may include a CPU or a programmable processor that can execute a program stored in a memory to perform specified functions. It may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the disclosure.

### First Embodiment

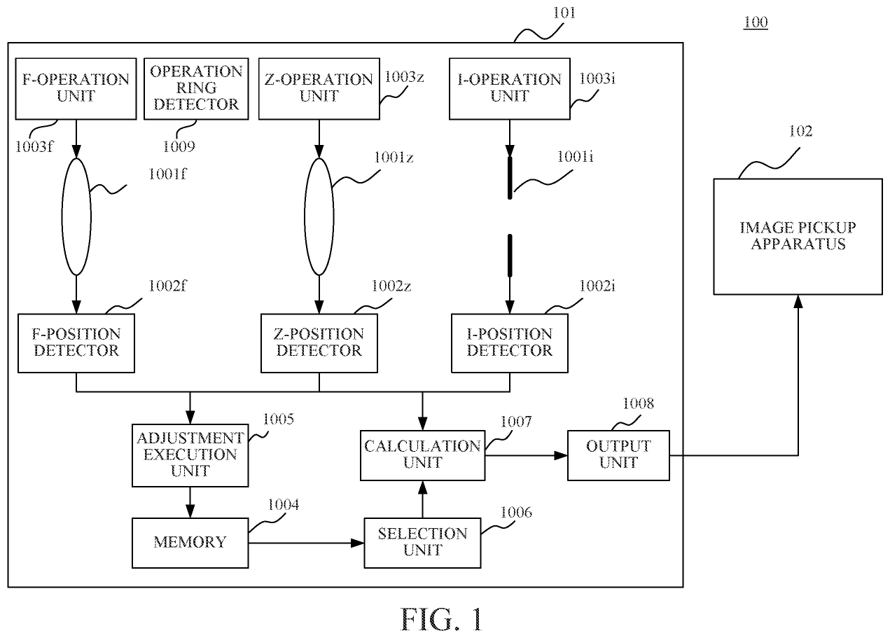

Referring now to FIGS. 1 to 10, a description will be given of a lens apparatus according to a first embodiment. FIG. 1 is a block diagram of an imaging system 100 according to this embodiment. The imaging system 100 includes an image pickup apparatus (camera body) 102 and a lens apparatus 101 attachable to and detachable from the image pickup apparatus 102.

The lens apparatus 101 forms an object image on an image sensor (not illustrated) in the image pickup apparatus 102 via a plurality of optical members such as a focus lens 1001f, a zoom lens 1001z, and a diaphragm (aperture stop) 1001i. A focus position detector (F-position detector hereinafter) 1002f, a zoom position detector (Z-position detector hereinafter) 1002z, and an aperture position detector (I-position detector hereinafter) 1002i are position detectors configured to detect the positions of focus lens 1001f, zoom lens 1001z, and diaphragm 1001i, respectively. In this embodiment, each position detector includes a potentiometer, and its detected value nonlinearly changes as the position of each optical member changes.

An F-operation unit 1003f, a Z-operation unit 1003z, and an I-operation unit 1003i are operation units that operate the focus lens 1001f, the zoom lens 1001z, and the diaphragm 1001i, respectively. Each operation unit in this embodiment includes an operation ring provided on the exterior of the lens apparatus 101 and mechanically connected with each optical member (such as an operation ring rotatable about an optical axis), but is not limited to this example. In this embodiment, the F-operation unit 1003f is an imperial operation ring (first operation unit) having a scale in units of feet (ft) (fps unit or imperial system) or a metric operation ring (second operation unit) having a scale in units of meters. The lens apparatus 101 is constructed such that an imperial operation ring and a metric operation ring are replaceable with each other. In this embodiment, in addition to the first operation unit and the second operation unit, the lens apparatus 101 may be configured so that at least one additional operation unit different from the first operation unit and the second operation unit is replaceable with them as the F-operation unit 1003f This is similarly applicable to the embodiments described below. The details of the scales of the imperial operation ring and the metric operation ring will be described below.

A memory (storage medium) 1004 is a memory for storing data, and stores data such as a plurality of optical information tables (optical information data), a plurality of detected value tables (detected value data), and selection information. The memory 1004 may be either a ROM (internal memory) inside the CPU or an external memory different from the CPU. Details of the optical information table and the detected value table will be described below. An adjustment execution unit 1005 is an execution unit that executes adjustment processing for changing the detected value table stored in the memory 1004. Details of the adjustment processing by the adjustment execution unit 1005 will be described below.

A selection unit (specifying unit) 1006 selects (specifies) an optical information table and a detected value table to be used from the plurality of optical information tables and the plurality of detected value tables. Details of selection processing (specifying processing) by the selection unit 1006 will be described below. A calculating unit (acquiring unit) 1007 calculates (acquires) optical information according to the current position of each optical member using the optical information table and the detected value table selected by the selection unit 1006. Details of the calculation processing (acquisition processing) by the calculation unit 1007 will be described below. An output unit 1008 outputs the optical information calculated by the calculation unit 1007 to the outside, and in this embodiment, outputs the information to the image pickup apparatus 102 using communication. Details of output processing by the output unit 1008 will be described below.

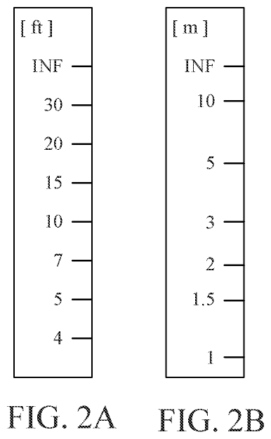

Referring now to FIGS. 2A and 2B, a description will be given of the imperial operation ring and metric operation ring as the F-operation unit 1003f FIGS. 2A and 2B explain the F-operation units 1003f FIG. 2A illustrates the scale of the imperial operation ring, which starts with 4 ft on the closest side and illustrates scales up to INF indicating infinity toward the infinity side. FIG. 2B illustrates the scale of the metric operation ring, which starts with 1 m on the closest side and illustrates scales up to INF indicating infinity toward the infinity side. These scales are printed at positions where the focus lens 1001f is located at the corresponding object distance. The user can intuitively operate the focus lens 1001f to a desired object distance by operating the F-operation unit 1003f based on the scale. Each scale has scale lines (index lines or indices), and by aligning a reference line (reference) provided on a fixed portion with an index line, a more accurate operation is available.

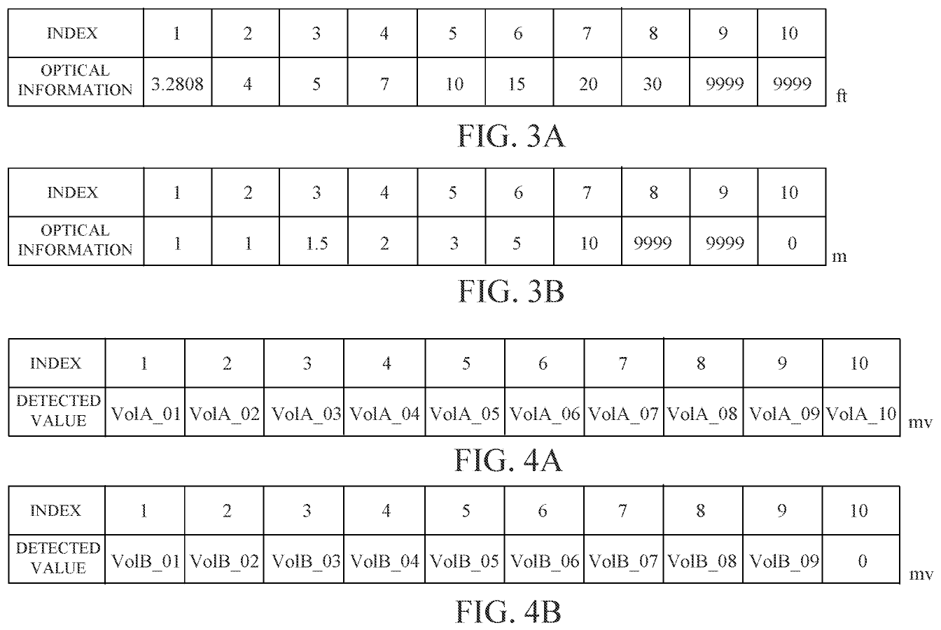

Referring now to FIGS. 3A and 3B, a detailed description will be given of the optical information tables stored in memory 1004. FIGS. 3A and 3B illustrate the optical information tables. FIG. 3A illustrates an optical information table corresponding to the imperial operation ring illustrated in FIG. 2A, and stores optical information corresponding to the imperial operation ring. Index 1 represents optical information corresponding to the closest end of the F-operation unit 1003f, and stores 3. 2808, which is metric to imperial conversion of 1 m as the minimum object distance (MOD) of the lens apparatus. Index 2 stores as optical information 4 ft, which is an index on the closest side. Similarly, respective indices up to Index 9 store optical information corresponding to respective indices. Index 9 represents an index of infinity, and stores 9999 as optical information. Index 10 stores optical information corresponding to the end of the F-operation unit 1003f on the infinity side, and stores the same optical information as INF as the index closest to infinity.

FIG. 3B is an optical information table corresponding to the metric operation ring illustrated in FIG. 2B, and stores optical information corresponding to the metric operation ring. Index 1 is optical information corresponding to the end of the F-operation unit 1003f on the closest side, and stores 1 indicating 1 m as MOD of the lens apparatus 101. Index 2 stores 1 as the optical information on 1 m, which is the index on the closest side. Similarly, optical information for each index up to Index 8 is stored. Index 8 is an index indicating infinity, and stores 9999 as the optical information. Index 9 stores optical information corresponding to the end of the F-operation unit 1003f on the infinity side, which is the same optical information as INF as the index closest to infinity. Index 10 is an unused index for the metric operation ring, and stores 0 indicating that it is not used as the optical information.

As described above, storing the optical information table in units of feet for the imperial operation ring and in units of meters for the metric operation ring can reduce the calculation error in the unit conversion calculation described below.

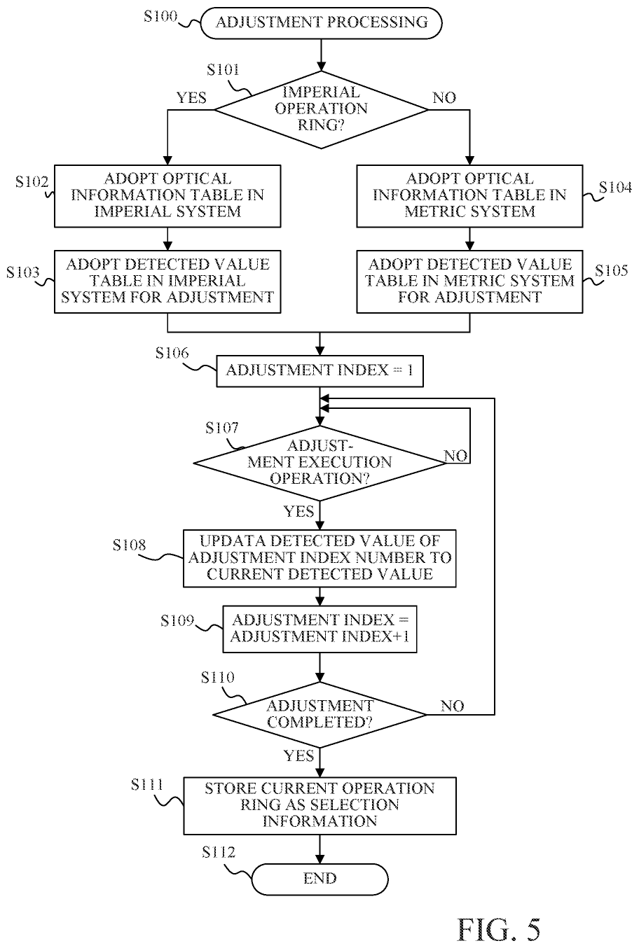

Referring now to FIGS. 4A and 4B, a detailed description will be given of the detected value tables stored in memory 1004. The detected value table can be rewritten by the adjustment processing by the adjustment execution unit 1005. Details of the adjustment processing by the adjustment execution unit 1005 will be described below.

FIG. 4A is the detected value table corresponding to the imperial operation ring illustrated in FIG. 2A, and stores detected values of the F-position detector 1002f at index positions on the imperial operation ring. The index number is correlated with the index number of the optical information table for the imperial operation ring illustrated in FIG. 3A, and Index 1 stores detected value VolA_01 of the F-position detector 1002f at the end of the closest side of the F-operation unit 1003f Index 2 stores detected value VolA_02 of the F-position detector 1002f at 3 ft, which is the closest index. Similarly, up to Index 9, the detected value of the F-position detector 1002f for each index is stored. Index 10 stores detected value VolA_10 of the F-position detector 1002f corresponding to the end of the F-operation unit 1003f on the infinity side.

FIG. 4B is the detected value table corresponding to the metric operation ring illustrated in FIG. 2B, and stores the detected values of the F-position detector 1002f at the index position on the metric operation ring. The index number is correlated with the index number of the optical information table for the metric operation ring illustrated in FIG. 3B, and Index 1 stores the detected value VolB_01 of the F-position detector 1002f at the end of the closest side of the F-operation unit 1003f Index 2 stores detected value VolB_02 of the F-position detector 1002f at 1 m, which is the closest index. Similarly, up to Index 8, the detected value of the F-position detector 1002f for each index is stored. Index 9 stores detected value VolB_09 of the F-position detector 1002f corresponding to the end of the F-operation unit 1003f on the infinity side. Index 10 is an unused index for a metric operation ring, and stores detected value 0 indicating that it is not used as the optical information. Assume that the detected value of the F-position detector 1002f never becomes 0.

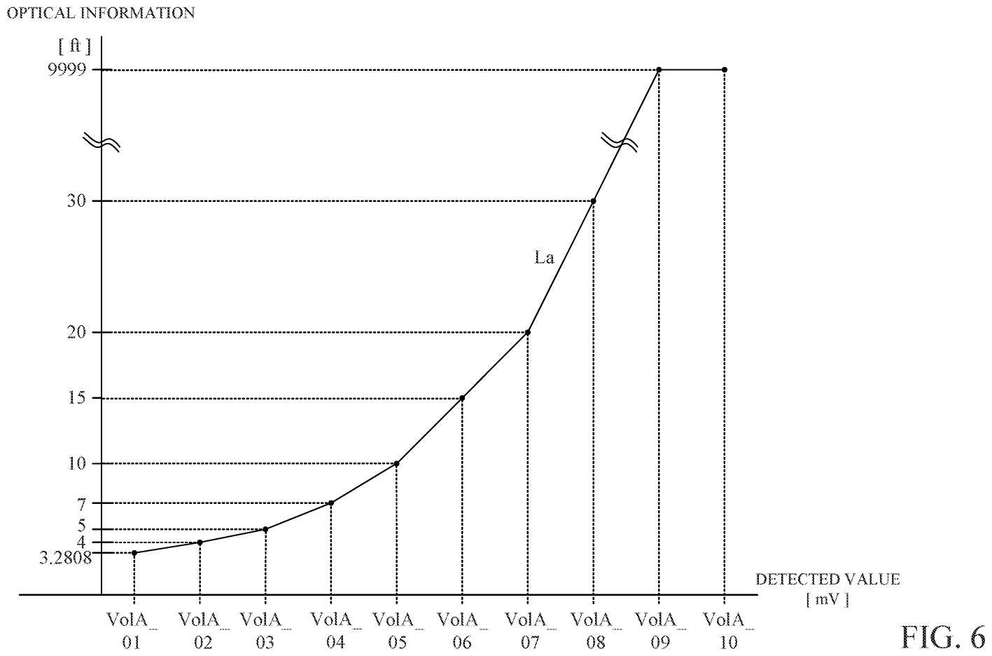

Referring now to FIG. 5, a detailed description will be given of the adjustment processing by the adjustment execution unit 1005. FIG. 5 is a flowchart of the adjustment processing. This flowchart is started in a case where an unillustrated operation unit instructs an adjustment start.

In a case where the adjustment execution unit 1005 starts the adjustment processing in step S100, the flow proceeds to step S101. Next, in step S101, the adjustment execution unit 1005 determines whether or not the operation ring (F-operation unit 1003) attached to the lens apparatus 101 is an imperial operation ring. In a case where the operation ring is the imperial operation ring, the flow proceeds to step S102. On the other hand, in a case where the operation ring is not the imperial operation ring, the flow proceeds to step S104. The operation ring is determined by the user setting at the adjustment start via the unillustrated operation unit.

In step S102, the adjustment execution unit 1005 adopts the optical information table in the imperial system as the optical information table for the adjustment processing. Next, in step S103, the adjustment execution unit 1005 adopts the detected value table in the imperial system as the detected value table for the adjustment processing.

In step S104, the adjustment execution unit 1005 adopts the optical information table in the metric system as the optical information table for the adjustment processing. Next, in step S105, the adjustment execution unit 1005 adopts the detected value table in the metric system as the detected value table for the adjustment processing.

Next, in step S106, the adjustment execution unit 1005 sets 1 to an adjustment index indicating the index for which adjustment is to be performed. Next, in step S107, the adjustment execution unit 1005 determines whether or not the user has performed an adjustment execution operation. In a case where there is the adjustment execution operation, the flow proceeds to step S108. On the other hand, if there is no adjustment execution operation, step S107 is repeated. Here, the user operates the F-operation unit 1003f to a position corresponding to the adjustment index, and performs an adjustment execution operation using the unillustrated operation unit. At this time, for example, a PC or the like is connected to the output unit 1008 to notify the user of the adjustment index via the PC, or to refer to the optical information table and notify the user of the optical information according to the adjustment index. Thereby, the user can smoothly perform the adjustment execution operation.

In step S108, the adjustment execution unit 1005 updates the detected value of the adjustment index number in the detected value table to the current detected value of the F-position detector 1002f Next, in step S109, the adjustment execution unit 1005 increments the adjustment index by 1. Next, in step S110, the adjustment execution unit 1005 determines whether or not the adjustment has been completed. In a case where the adjustment has been completed, the flow proceeds to step S111. On the other hand, in a case where the adjustment has not yet been completed, the flow returns to step S107. This embodiment determines that the adjustment has been completed in a case where the optical information corresponding to the adjustment index of the optical information table is 0 or in a case where the adjustment index becomes larger than 10, which is the maximum value of the index.

In step S111, the adjustment execution unit 1005 stores in the memory 1004 which one is the current operating ring as selection information. Here, the selection information is information on the operation ring in a case where the last adjustment processing was performed. Next, in step S112, the adjustment execution unit 1005 ends the adjustment processing.

According to the flow described above, the user can rewrite the detected value in the detected value table at the index position on the F-operation unit 1003f.

A description will now be given of selection processing for selecting an optical information table and a detected value table to be used from a plurality of optical information tables and a plurality of detected value tables by the selection unit 1006. The selection unit 1006 according to this embodiment refers to the optical information table and detected value table corresponding to the selection information stored in the memory 1004. That is, this embodiment does not depend on which operating ring is currently used.

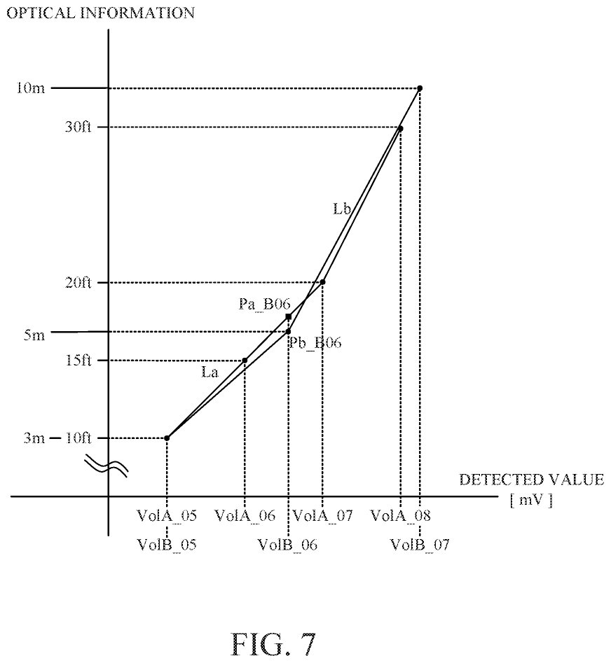

Referring now to FIG. 6, a description will be given of calculation processing for calculating optical information according to the current position of the focus lens 1001f by the calculation unit 1007 using the optical information table and the detected value table. A description will now be given of a case where the selection unit 1006 refers to the optical information table and detected value table corresponding to the imperial operation ring.

FIG. 6 explains the calculation processing and is a graph that illustrates a relationship between the optical information table and the detected value table in the imperial operation ring. In FIG. 6, the horizontal axis indicates a detected value, and the vertical axis indicates optical information. A graph line La is acquired by approximating and interpolating each space between indices with a straight line using the optical information table and the detected value table for the imperial operation ring stored in the memory 1004.

The calculation unit 1007 calculates optical information in the imperial system from the current detection result of the F-position detector 1002f using the graph line La generated from the optical information table and the detected value table by the selection unit 1006. The calculation unit 1007 performs a unit conversion based on the calculated optical information in the imperial system and calculates optical information in the metric system. The processing for calculating the optical information corresponding to the metric operation ring in a case where the selection unit 1006 refers to the optical information table and the detected value table corresponding to the metric operation ring is similar to that for the imperial operation ring.

A description will now be given of an output of data from the output unit 1008. The output unit 1008 is a communication unit that communicates with the image pickup apparatus 102 and outputs optical information in response to a request from the image pickup apparatus 102. That is, in a case where the optical information is requested in the imperial system, the optical information in the imperial system is returned, and in a case where the optical information is requested in the metric system, the optical information in the metric system is output. This configuration can perform adjustment according to the attached operation ring, and calculate optical information by properly using the adjustment value (adjustment value data).

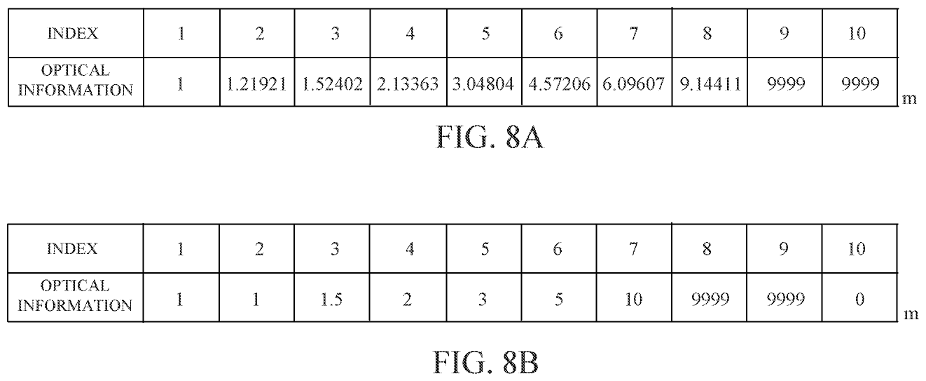

Referring now to FIG. 7, a description will be given of the effects of this embodiment. FIG. 7 explains the calculation processing and is a graph that illustrates a relationship between the optical information table and the detected value table. In FIG. 7, the horizontal axis indicates a detected value, and the vertical axis indicates optical information. A graph line La is the same as the graph line La in the graph of FIG. 6, and is partially enlarged for description purposes. A graph line Lb is acquired by approximating and interpolating each space between indices with a straight line using the optical information table and the detected value table of the metric operation ring stored in the memory 1004. That is, the optical information is calculated based on the graph line La in a case where the selection information is the imperial operation ring, and based on the graph line Lb in a case where the selection information is the metric operation ring.

Now consider calculation of optical information in a case where the adjustment processing is performed for the imperial operation ring and then the imperial operation ring is replaced with the metric operation ring without performing the adjustment processing. That is, the metric operation ring is attached, but the optical information is calculated based on the graph line La. The detected value is B_06 in a case where the operation ring is set to an index of 5 m, and the optical data calculated at that time is a value slightly shifted from 5 m, as indicated by Pa_B06. That is, in a case where the operation ring is aligned with the index of 5 m, a value with an error is output to the imaging system 100 instead of an accurate value of 5 m.

On the other hand, assume that the imperial operation ring is replaced with the metric operation ring and the adjustment processing is performed, that is, the metric operation ring is attached and the optical information is calculated based on the graph line Lb. The detected value in a case where the operation ring is aligned with the 5 m index is B_06, and the adjustment processing is performed at that index position. Therefore, the optical data calculated at that time can be accurately 5 m as illustrated by Pb_B06.

As described above, the adjustment processing according to the index position and the properly selected detected value table and optical information table for calculating the optical information can calculate and output the optical data without errors at the index position. Even if the metric operation ring is used without the adjustment processing after the adjustment processing is performed for the imperial operation ring, it is unnecessary to again perform the adjustment processing for the metric operation ring as long as the error is permissible.

### First Variation

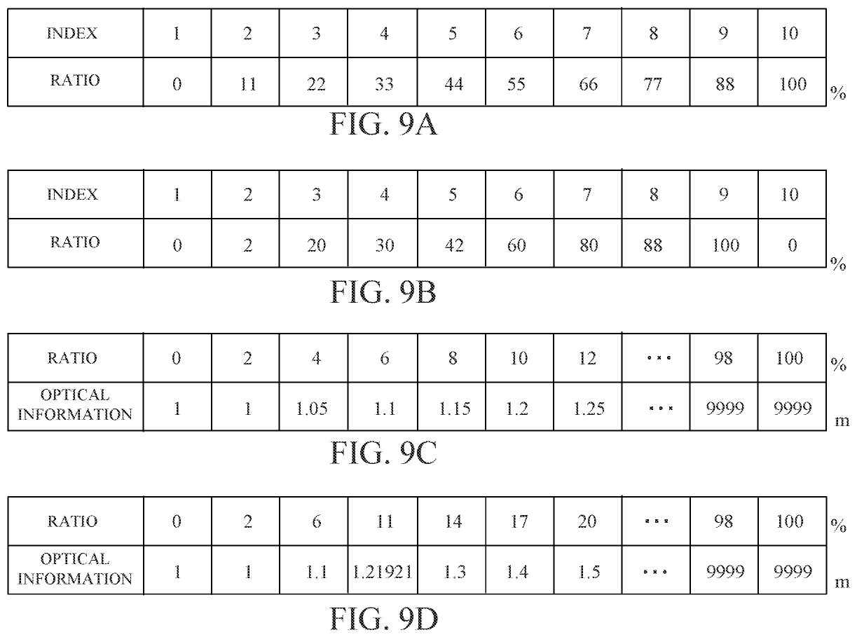

In this embodiment, the optical information table stores optical information in the imperial system for the imperial operation ring and optical information in the metric system for the metric operation ring, but the disclosure is not limited to this example. FIGS. 8A and 8B explain optical information tables in a first variation of this embodiment. As illustrated in FIGS. 8A and 8B, imperial-to-metric conversion values may be stored even for the imperial operation ring. Thereby, the optical information in the optical information table in each case becomes unified concept information, so it is unnecessary to manage which optical information table is used in the calculation processing in the calculation unit 1007.

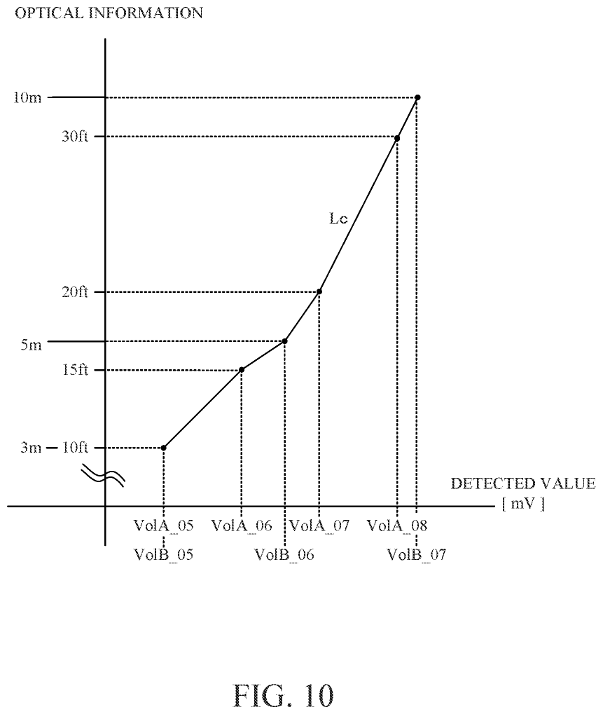

FIGS. 9A to 9D explain optical information tables in this variation. FIG. 9A is index ratio information for the imperial operation ring, and is a table illustrating ratio information according to each index. More specifically, for example, an index position of 4 ft corresponding to Index 2 indicates a position 11% inside from the end of MOD in a case where the entire movable range of the focus lens 1001f is set to 100%. Similarly, FIG. 9B is index ratio information for the metric operation ring, and is a table illustrating ratio information according to each index. The calculation unit 1007 first calculates ratio information for the entire area from the detection result of the F-position detector 1002f and the index ratio information.

Thereafter, as illustrated in FIG. 9C, the optical ratio information is used to calculate an object distance as the optical information, from the ratio information on the entire area. Storing the optical ratio information in more detail can calculate optical information with higher accuracy even in areas without indices, based on a table divided more finely than the index interval on the F-operation unit 1003f.

As illustrated in FIG. 9D, always storing optical information that matches the index position ratio in the optical ratio information can minimize the influence of calculation errors in calculating the object distance at the index position.

In this embodiment, optical information is calculated as an example by linear approximation, but the disclosure is not limited to this example. For example, since the object distance is generally proportional to a reciprocal of a moving amount of the focus lens 1001f, approximation may be performed using the reciprocal. Alternatively, an approximation equation calculated based on lens design information may be stored and the approximation may be performed using the approximation equation.

### Second Variation

In this embodiment, the selection unit 1006 selects the detected value table and the optical information table based on the selection information on the operation ring for which the adjustment processing was last performed, but the disclosure is not limited to this example. The lens apparatus 101 further includes an operation ring detector (identifying unit) 1009 for detecting (identifying) the operation ring attached to the lens apparatus 101, as illustrated in FIG. 1. The selection unit 1006 may select the tables to be used based on the detection result by the operation ring detector 1009. That is, in a case where the operation ring detector 1009 detects the imperial operation ring, the optical information table and detected value table for the feet are adopted, and in a case where the operation ring detector 1009 detects the metric operation ring, the selection unit 1006 may select the optical information table and detected value table for the metric system. In this case, since the tables corresponding to the attached operation ring are referred to, correct optical information can be calculated at the index position of the operation ring without again performing adjustment after the operation ring is replaced.

However, in one embodiment, adjustment processing for both operation rings before shipping or after the operation ring is first replaced is performed. In a case where the index position may shift during the replacement work of the operation ring, the adjustment processing may be performed whenever the operation ring is replaced.

It may be determined whether adjustment processing has been performed for the operation ring corresponding to the detection result by the operation ring detector 1009, that is, whether a correct value is stored in the adjustment value. For example, in one embodiment, whether or not a value that is not invalid is stored as a detected value for each of all indices in the detected value table is confirmed. It is conceivable to select tables to be used based on the detection result in a case where the detected values are stored, and based on information about the operation ring for which the adjustment processing was last performed in a case where the detected values are not stored. This configuration can calculate optical information while allowing errors even if no adjustment processing is performed after the operation ring is replaced.

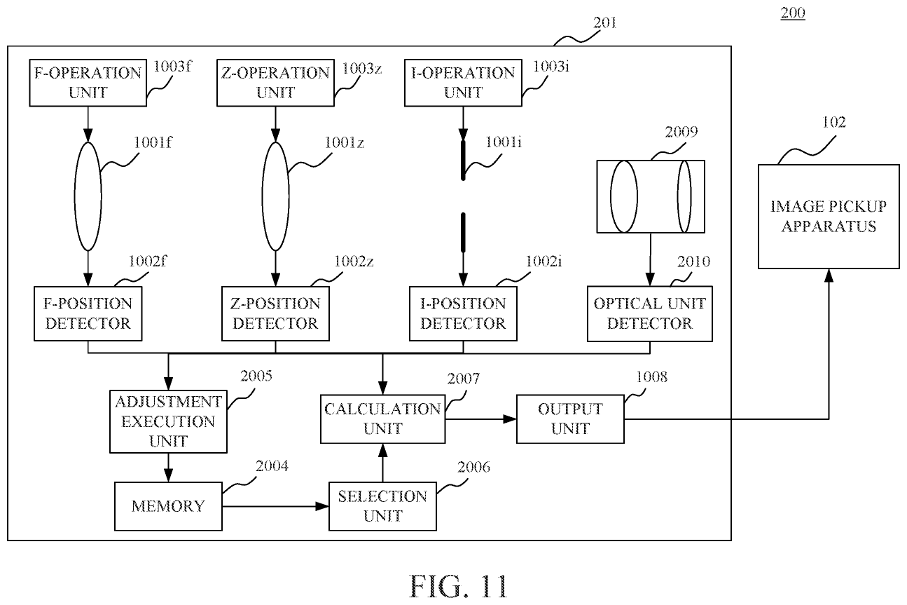

The selection unit 1006 may select all tables that store correct values to be used for adjustment values. For example, in a case where this embodiment selects all tables that store correct values to be used for adjustment values, a graph illustrated in FIG. 10 is used. FIG. 10 explains the calculation processing according to this variation and is a graph that illustrates a relationship between optical information and a detected value. In FIG. 10, the horizontal axis indicates a detected value, and the vertical axis indicates optical information. In this case, the optical information may be set in the imperial or metric system as illustrated in FIGS. 8A and 8B, or stored as ratio information as illustrated in FIGS. 9A to 9D. Thereby, the calculation unit 1007 can calculate optical information using unified concept information.

The selection unit 1006 may select tables in response to a request from the image pickup apparatus 102. More specifically, in a case where there is a data acquisition request in the imperial system from the image pickup apparatus 102, the optical information table and detected value table in the imperial system may be adopted, and in a case where there is a data acquisition request in the metric system, the optical information table and detected value table in the metric system may be adopted. Thereby, the matching level can be improved between the value in the unit required by the image pickup apparatus 102 and the index in that unit.

In a case where the adjustment processing is performed for the imperial operation ring and then the imperial operation ring is replaced with the metric operation ring without adjustment processing, that is, in a case where a value with an error is output at the index position, a notification may be sent to the operator who has replaced the operating ring. More specifically, in a case where the detection result of the operation ring detector 1009 and the selection result of the detected value table by the selection unit 1006 are different, a notification is sent. The notification may be made, for example, by lighting an unillustrated LED, or by connecting a PC or the like to the output unit 1008 and notifying the user via the PC. Thereby, the adjustment processing can be prevented from being forgot after the operation ring is replaced.

In the F-operation unit 1003f in this embodiment, the imperial operation ring and the metric operation ring are replaceable with each other, but the disclosure is not limited to this example. For example, in the I-operation unit 1003i, an F-number operation ring and a T-number operation ring may be replaceable. In the Z-operation unit 1003z, a focal length operation ring and an angle of view operation ring may be replaceable. Operation rings may be replaceable for focal lengths corresponding to image pickup apparatuses with different image sensor sizes.

The operation rings are illustrated for the F-operation unit 1003f, but the disclosure is not limited to this example. An operation unit that is mechanically operable via a gear, an operation unit that is electrically operable via a connector or using communication may be applicable. In the latter case, a driving unit (not illustrated) such as a motor is used.

### Second Embodiment

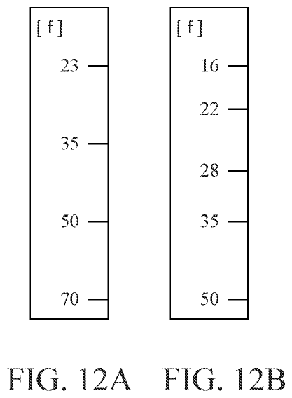

Referring now to FIGS. 11 to 19G, a description will be given of a lens apparatus according to a second embodiment. FIG. 11 is a block diagram of an imaging system 200 according to this embodiment. The imaging system 200 includes an image pickup apparatus (camera body) 102 and a lens apparatus 201 that is attachable to and detachable from the image pickup apparatus 102. Those elements in this embodiment, which are corresponding elements of the lens apparatus 101 in the first embodiment, will be designated by the same reference numerals as those in FIG. 1, and a description thereof will be omitted.

A memory 2004 is a memory for storing data. The configuration of the memory 2004 is the same as that of the memory 1004 in the first embodiment, but stored information is different. Details of the optical information table and the detected value table in this embodiment will be described below. An adjustment execution unit 2005 is an execution unit that executes adjustment processing for changing the detected value table stored in the memory 2004. Details of the adjustment processing by the adjustment execution unit 2005 will be described below. A selection unit (specifying unit) 2006 selects (specifies) an optical information table and a detected value table to be used from a plurality of optical information tables and a plurality of detected value tables. Details of selection processing (specifying processing) by the selection unit 2006 will be described below. A calculation unit (acquiring unit) 2007 calculates (acquires) optical information according to the current position of each optical member using the optical information table and the detected value table selected by the selection unit 2006. Details of the calculation processing (acquisition processing) by the calculation unit 2007 will be described below.

An optical unit 2009 in the lens apparatus 201 is a relay unit that guides a light beam from the lens apparatus 201 to the image pickup apparatus 102. As the optical unit 2009 in the lens apparatus 201, an optical unit (first optical unit) that guides a light ray to a full frame 35 mm (or 35 mm full size: 36 mm×24 mm) (simply referred to as full-frame hereinafter) image circle and an optical unit (second optical unit) that guides a light ray to a super 35 mm (24 mm×14 mm) (simply referred to as super-35 hereinafter) image circle are replaceable with each other. The second optical unit is a reduction optical system with a magnification of about 0.7 times as high as that of the first optical unit. Since a corresponding image circle is smaller, the lens can be made brighter. In this case, a focal length increases by about 0.7 times, and the brightness corresponding to the aperture diameter increases by about one stage. Therefore, the focal length and brightness are different between the normal optical unit and the reduction optical system unit. In other words, in replacing the optical unit, the zoom and aperture operation rings with operation rings (first and second operation rings) are replaced according to their respective optical characteristics. Assume that the object distance does not change according to the optical unit. An optical unit detector 2010 is a detector (identifying unit) that detects which of the full-frame optical unit and the super-35 optical unit is installed as the optical unit 2009.

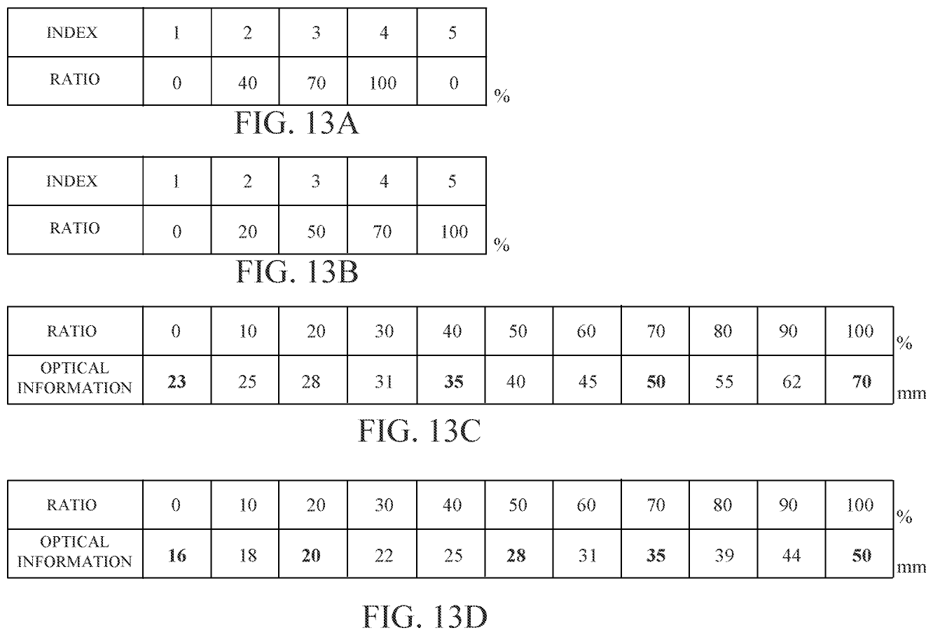

A description will now be given of zoom in this embodiment. Referring now to FIGS. 12A and 12B, a description will be given of a full-frame zoom operation ring (first operation ring) and a super-35 zoom operation ring (second operation ring) in the Z-operation unit 1003z. FIGS. 12A and 12B explain the Z-operation unit 1003z. FIG. 12A illustrates a scale for the full-frame zoom operation ring, and the scale is printed from 23 mm on the wide-angle side to 70 mm on the telephoto side. FIG. 12B illustrates a scale of the super-35 zoom operation ring, and the scale is printed from 16 mm on the wide-angle side to 50 mm on the telephoto side. These printed scales correspond to the focal length of the zoom lens 1001z in a case where each optical unit is attached. By operating the Z-operation unit 1003z based on the scale, the user can intuitively operate the zoom lens 1001z to a desired focal length. Each scale has scale lines (index lines or indices), and aligning an unillustrated reference line of the fixed portion with the index line can provide a more accurate operation.

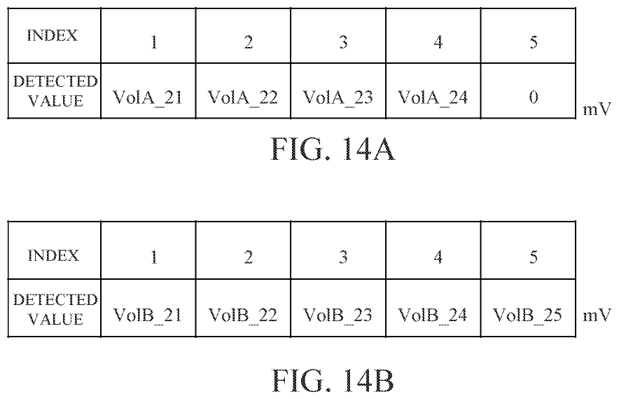

Referring now to FIGS. 13A to 13D, a detailed description will be given of optical information tables for zoom. FIGS. 13A to 13D explain zoom optical information tables. Each optical information table for zoom includes a combination of index ratio information illustrated in FIGS. 9A to 9D as a ratio to an operation range operable by the operation ring, and optical ratio information as optical information according to the ratio to the operation range in the optical member.

FIG. 13A is index ratio information in the optical information table corresponding to the full-frame zoom operation ring illustrated in FIG. 12A and stores ratio information to the operable operation range according to the full-frame zoom operation ring. FIG. 13B is index ratio information in the optical information table corresponding to the super-35 zoom operation ring illustrated in FIG. 12B and stores ratio information to the operable operation range according to the super-35 zoom operation. A specific description method of each table is similar to that of the first embodiment, and a description thereof will be omitted.

FIG. 13C illustrates optical ratio information in a case where the full-frame optical unit is attached, and a focal length can be calculated as the optical information based on the ratio information to the entire area in a case where the full-frame optical unit is attached. Similarly, FIG. 13D illustrates optical ratio information in a case where the super-35 optical unit is attached, and a focal length can be calculated as the optical information based on the ratio information to the entire area in a case where the super-35 optical unit is attached. In FIGS. 13C and 13D, bold numbers indicate index positions.

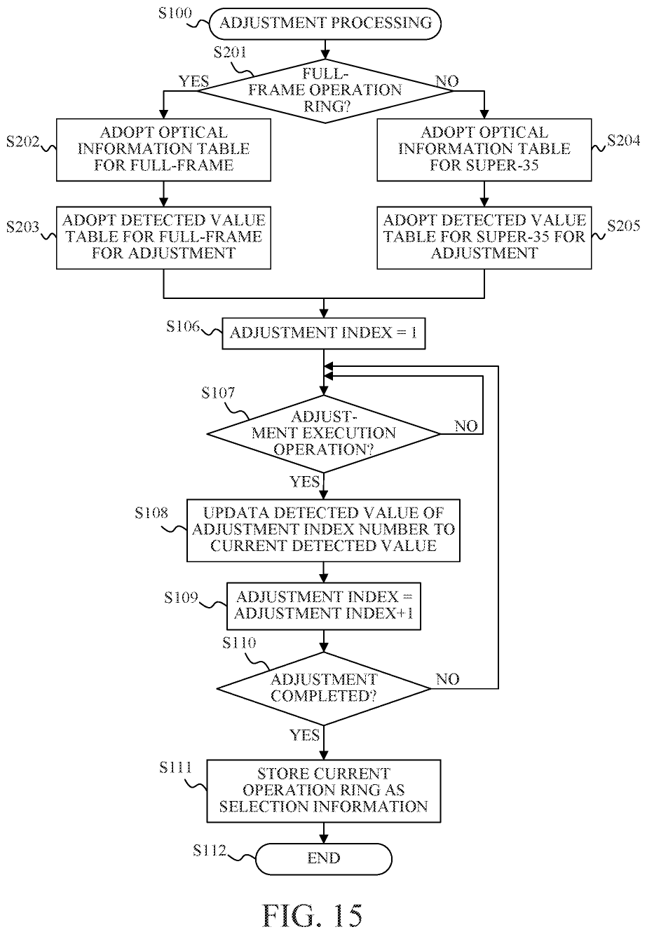

Referring now to FIGS. 14A and 14B, a detailed description will be given of detected value tables for zoom. Each detected value table is rewritable through adjustment processing by the adjustment execution unit 2005. Details of the adjustment processing by the adjustment execution unit 2005 will be described below. FIG. 14A is a detected value table corresponding to the full-frame zoom operation ring illustrated in FIG. 12A, and stores detected values of the Z-position detector 1002z at index positions of the full-frame zoom operation ring. Similarly, FIG. 14B is a detected value table corresponding to the super-35 zoom operation ring illustrated in FIG. 12B, and stores detected values of the Z-position detector 1002z at index positions of the super-35 zoom operation ring.

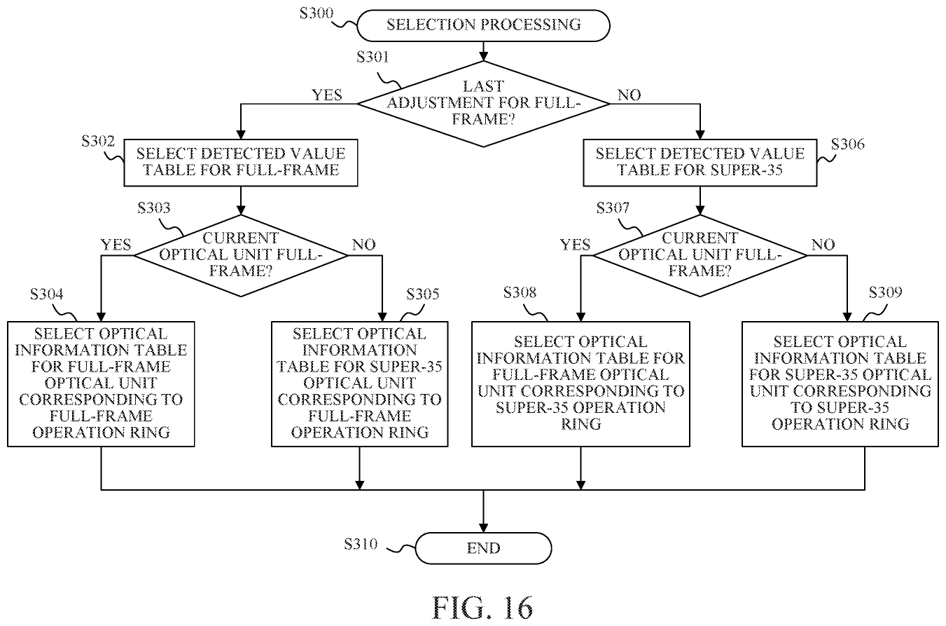

Referring now to FIG. 15, a detailed description will be given of adjustment processing performed by the adjustment execution unit 2005. FIG. 15 is a flowchart of the adjustment processing. Those elements in FIG. 15, which are corresponding elements of the first embodiment, will be designated by the same reference numerals as those of FIG. 5, and a description thereof will be omitted.

First, in a case where the adjustment execution unit 2005 starts the adjustment processing in step S100, the flow proceeds to step S201. In step S201, the adjustment execution unit 2005 determines whether or not the zoom operation ring attached to the lens apparatus 201 is a full-frame zoom operation ring. In a case where the zoom operation ring is the full-frame zoom operation ring, the flow proceeds to step S202. On the other hand, in a case where the zoom operation ring is not the full-frame zoom operation ring, the flow proceeds to step S204. The operation ring is determined performed by the user setting at the adjustment start via the unillustrated operation unit.

In step S202, the adjustment execution unit 2005 adopts the optical information table in a case where the full-frame optical unit is attached, which corresponds to the full-frame zoom operation ring, as the optical information table for the adjustment processing. That is, a combination of the index ratio information illustrated in FIG. 13A and the optical ratio information illustrated in FIG. 13C is adopted. Next, in step S203, the adjustment execution unit 2005 adopts the detected value table corresponding to the full-frame zoom operation ring as the detected value table for the adjustment processing.

In step S204, the adjustment execution unit 2005 adopts the optical information table in a case where the super-35 optical unit is attached, which corresponds to the super-35 zoom operation ring, as the optical information table for the adjustment processing. That is, a combination of the index ratio information illustrated in FIG. 13B and the optical ratio information illustrated in FIG. 13D is adopted. Next, in step S205, the adjustment execution unit 2005 adopts the detected value table corresponding to the super-35 zoom operation ring as the detected value table for the adjustment processing. The flow after FIG. 15 is similar to the flow in FIG. 5.

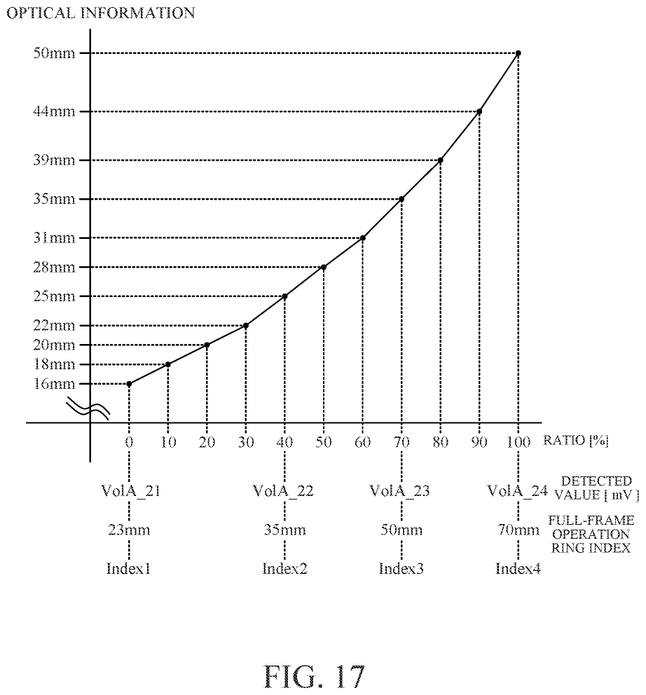

Referring now to FIG. 16, a description will be given of selection processing for selecting an optical information table and a detected value table to be used from a plurality of optical information tables and a plurality of detected value tables by the selection unit 1006. FIG. 16 is a flowchart of the selection processing.

First, in a case where the selection unit 1006 starts the selection processing in step S300, the flow proceeds to step S301. In step S301, the selection unit 1006 determines, based on the selection information stored in the memory 1004, whether or not the operation ring for which adjustment processing was last performed is a full-frame zoom operation ring. In a case where the operation ring is the full-frame zoom operation ring, the flow proceeds to step S302. On the other hand, in a case where the operation ring is not the full-frame zoom operation ring, the flow proceeds to step S303.

In step S302, the selection unit 1006 selects the detected value table corresponding to the full-frame zoom operation ring. Next, in step S303, the selection unit 1006 determines whether or not the current optical unit is a full-frame optical unit based on the detection result of the optical unit detector 2010. In a case where the optical unit is the full-frame optical unit, the flow proceeds to step S304. On the other hand, in a case where the optical unit is not a full-frame optical unit, the flow proceeds to step S305.

In step S304, the selection unit 1006 selects an optical information table in a case where the full-frame optical unit is attached, which corresponds to the full-frame zoom operation ring. That is, a combination of the index ratio information illustrated in FIG. 13A and the optical ratio information illustrated in FIG. 13C is adopted. In step S305, the selection unit 1006 selects an optical information table in a case where a super-35 optical unit is attached, which corresponds to the full-frame zoom operation ring. That is, a combination of the index ratio information illustrated in FIG. 13A and the optical ratio information illustrated in FIG. 13D is adopted.

In step S306, the selection unit 1006 selects a detected value table corresponding to the super-35 zoom operation ring. Next, in step S307, the selection unit 1006 determines whether or not the current optical unit is a full-frame optical unit based on the detection result of the optical unit detector 2010. In a case where the optical unit is the full-frame optical unit, the flow proceeds to step S308. On the other hand, in a case where the optical unit is not the full-frame optical unit, the flow proceeds to step S309.

In step S308, the selection unit 1006 selects an optical information table in a case where the full-frame optical unit is attached, which corresponds to the super-35 zoom operation ring. That is, a combination of the index ratio information illustrated in FIG. 13B and the optical ratio information illustrated in FIG. 13C is adopted. In step S309, the selection unit 1006 selects an optical information table in a case where the super-35 optical unit is attached, which corresponds to the super-35 zoom operation ring. That is, a combination of the index ratio information illustrated in FIG. 13B and the optical ratio information illustrated in FIG. 13D is adopted. Then, in step S310, the selection process ends.

A description will now be given of the calculation processing of the zoom optical information by the calculation unit 2007. A description will now be given of a case where the flow proceeds to step S304 in the flowchart of FIG. 16. This is a case that selects the detected value table corresponding to the full-frame zoom operation ring and the optical information table in a case where the full-frame optical unit is attached, which corresponds to the full-frame zoom operation ring. That is, this is a case that selects an optical information table that includes a combination of the index ratio information illustrated in FIG. 13A and the optical ratio information illustrated in FIG. 13C, and the detected value table illustrated in FIG. 14A. In this case, the concept of the calculation processing according to the first embodiment described with reference to FIGS. 9A to 9D is similarly applied, and a description thereof will be omitted.

A description will now be given of a case of proceeding to step S305 in the flowchart of FIG. 16. This is a case that selects the detected value table corresponding to the full-frame zoom operation ring and the optical information table in a case where the super-35 optical unit is attached, which corresponds to the full-frame zoom operation ring. That is, this is a case that selects an optical information table that includes a combination of the index ratio information illustrated in FIG. 13A and the optical ratio information illustrated in FIG. 13D, and the detected value table illustrated in FIG. 14A. In this case, the detected value table stores detected values at index positions of the full-frame zoom operation ring. On the other hand, the current optical unit is the super-35 optical unit, and there is a discrepancy between the selected detected value table and the current optical unit.

Accordingly, this variation selects an optical information table by combining the index ratio information corresponding to the full-frame zoom operation ring and the optical ratio information in a case where the super-35 optical unit is attached. This makes it possible to absorb the deviation between the selected detected value table and the configured optical unit. That is, it is possible to generate optical information in a case where the super-35 optical unit is attached from the detected value table corresponding to the full-frame zoom operation ring.

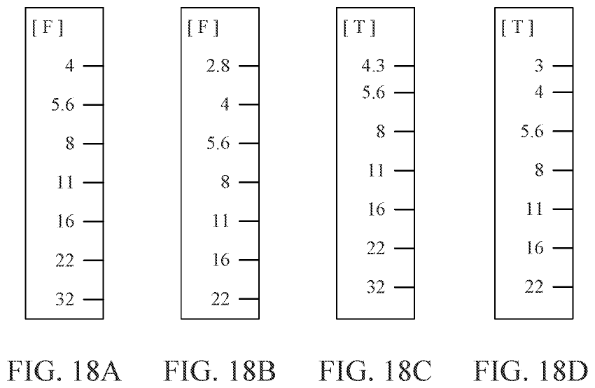

A specific description will be given with reference to FIG. 17. FIG. 17 explains the calculation processing. FIG. 17 is a graph that illustrates a relationship in a case that selects a detected value table corresponding to the full-frame zoom operation ring and an optical information table in a case where the super-35 optical unit is attached, which corresponds to the full-frame zoom operation ring. In FIG. 17, the horizontal axis indicates a position of the zoom lens 1001z, and the vertical axis indicates optical information.

Since the detected value table illustrated in FIG. 14A stores detected values at index positions of the full-frame zoom operation ring, a detected value at Index 2 is adjusted to VolA_22 at a position that describes an index of 35 mm on the full-frame zoom operation ring. Based on the index ratio information corresponding to the full-frame zoom operation ring illustrated in FIG. 13A, a ratio to the entire movable range is 40% at the position of Index 2. Based on the optical ratio information in a case where the super-35 optical unit illustrated in FIG. 13D is attached, it is understood that the optical information at the position of 40% is 25 mm. Thus, the optical information can be calculated in a case where the super-35 optical unit is attached using the detected value VolA_22 at the position of Index2 adjusted for the full-frame zoom operation ring. In FIG. 16, a case where the flow proceeds to step S308 or step S309 is similar to a case where the flow proceeds to step S304 or S305, so a description thereof will be omitted.

As described above, the calculation unit 2007 can calculate proper optical information using the detection result of the Z-position detector 1002z, the selection information that is information on the operation ring for which adjustment processing was last performed, and the detection result of the currently attached optical unit. Therefore, adjustment can be performed according to the attached zoom operation ring attached during adjustment, optical information can be calculated according to the current optical unit 2009 properly using the adjustment value.

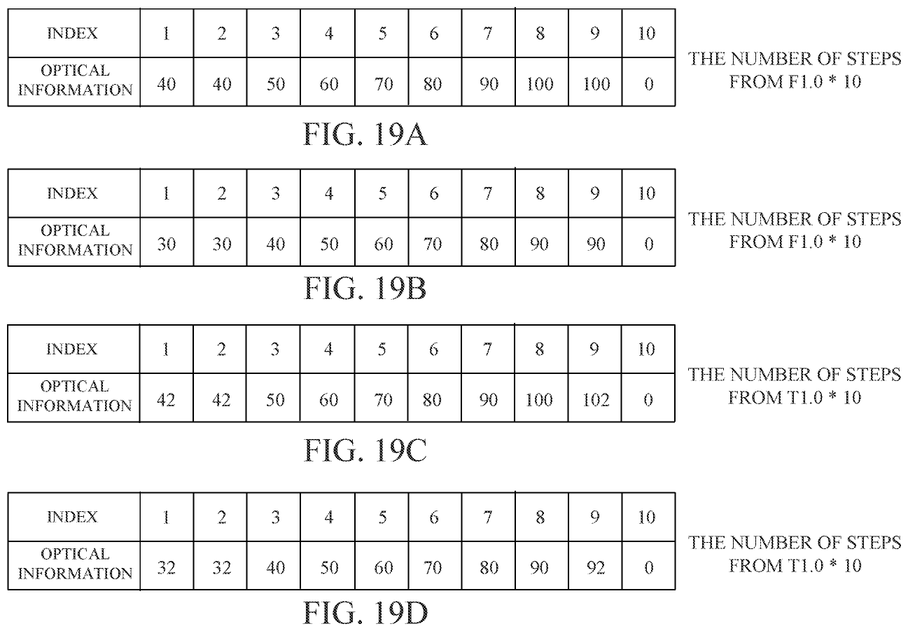

A description will be given of the diaphragm 1001i. Referring now to FIGS. 18A to 18D, a description will be given of a full-frame aperture F-number operation ring, a super-35 aperture F-number operation ring, a full-frame aperture T-number operation ring, and a super-35 aperture T-number operation ring in the I-operation unit 1003i. FIGS. 18A to 18D explain the I-operation unit 1003i. FIG. 18A illustrates a scale on the full-frame aperture F-number operation ring, which is printed from F4 on the open aperture side to F32 on the closing side. FIG. 18B illustrates a scale on the super-35 aperture F-number operation ring, which is printed from F2.8 on the open aperture side to F22 on the closing side. FIG. 18C illustrates a scale of the full-frame aperture F-number operation ring, which is printed from T4.3 on the open aperture side to T32 on the closing side. FIG. 18D illustrates a scale on the super-35 aperture T-number operation ring, and which is printed from 3 on the open aperture side to T22 on the closing side.

These scales are printed at positions where the diaphragm 1001i has an F-number or T-number in a case where each optical unit is attached. By operating the I-operation unit 1003i based on the scale, the user can intuitively operate the diaphragm 1001i to a desired F-number or T-number. Each scale has scale lines (index lines), and aligning an unillustrated reference line of the fixed portion with the index line can provide a more accurate operation.

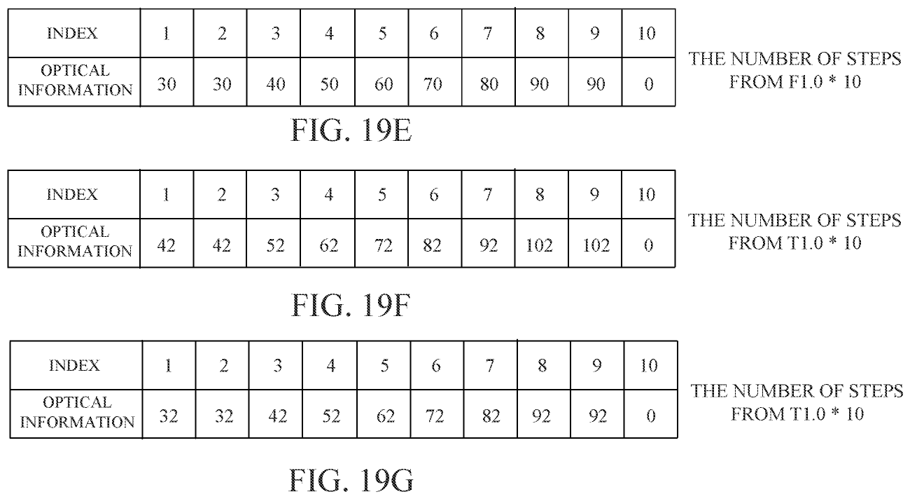

Referring now to FIGS. 19A to 19G, a detailed description will be given of the optical information table for the diaphragm 1001i. FIGS. 19A to 19G explain the optical information table for the diaphragm 1001i.

FIG. 19A is an optical information table for the F-number in a case where a full-frame optical unit is attached, which corresponds to the full-frame aperture F-number operation ring illustrated in FIG. 18A. Optical information corresponding to the F-number at the index printed on the full-frame diaphragm F-number operation ring is stored as the optical information. The optical information here has a value obtained by multiplying the number of steps from F1.0 by 10, and the optical information and the F-number can be mutually converted using the following equations 1 and 2:

F-number=2\hat{ }((optical information)/20) (1)

Optical Information=Log₂((F-number)×20) (2)

Similarly, FIG. 19B is an optical information table for the F-number in a case where a super-35 optical unit is attached, which corresponds to the super-35 aperture F-number operation ring illustrated in FIG. 18B. Optical information corresponding to the F-number at the index printed on the super-35 aperture F-number operation ring is stored as the optical information.

FIG. 19C is an optical information table for the T-number in a case where a full-frame optical unit is attached, which corresponds to the full-frame aperture T-number operation ring illustrated in FIG. 18C. Optical information corresponding to the T-number at the index printed on the full-frame aperture T-number operation ring is stored as the optical information. The optical information here is a value obtained by multiplying the number of steps from T1.0 by 10, and the optical information and the T-number can be mutually converted using the following equations 3 and 4.

T-number=2\hat{ }((optical information)/20) (3)

Optical Information=Log₂((T-number)×20) (4)

Similarly, FIG. 19D is an optical information table for the T-number in a case where a super-35 optical unit is attached, which corresponds to the super-35 aperture T-number operation ring illustrated in FIG. 18D. Optical information corresponding to the T-number at the index printed on the super-35 aperture T-number operation ring is stored as the optical information.

FIG. 19E is an optical information table for the F-number in a case where a super-35 optical unit is attached, which corresponds to the full-frame aperture F-number operation ring illustrated in FIG. 18A. FIG. 19F is an optical information table for the T-number in a case where a full-frame optical unit is attached, which corresponds to the full-frame aperture F-number operation ring illustrated in FIG. 18A. FIG. 19G is an optical information table of the T-number in a case where a super-35 optical unit is attached, which corresponds to the full-frame aperture F-number operation ring illustrated in FIG. 18A. That is, FIGS. 19E to 19G illustrate optical information tables to be used in a case where the operation ring for adjustment processing does not match the state of the optical unit and the type of optical information to be obtained in calculating the optical information. This is similarly applicable to another combination of an optical information table, such as an optical information table for the F-number in a case where a full-frame optical unit is attached, which corresponds to the super-35 aperture F-number operation ring, and thus a description will be omitted.

A detailed description will now be given of detected value tables for the diaphragm 1001i. Assume that the detected value tables for the diaphragm 1001i have and can store four types of detected value tables corresponding to four types of aperture operation rings. Details are the same as the zoom in the first or second embodiment, and a description thereof will be omitted.

A detailed description will now be given of aperture adjustment processing by the adjustment execution unit 2005. The aperture adjustment processing rewrites one of the four types of aperture operating rings according to the aperture operating ring attached during adjustment. Details are the same as the zoom in the first or second embodiment, and a description thereof will be omitted.

A description will now be given of selection processing for selecting an optical information table and a detected value table to be used from a plurality of optical information tables and a plurality of detected value tables by the selection unit 1006. First, similarly to the zoom of the first or second embodiment, the detected value table based on the operation ring for which the adjustment processing was last performed is selected based on the selection information stored in the memory 1004. More specifically, for example, if the operation ring for which the adjustment processing was last performed is the full-frame aperture F-number operation ring, the detected value table corresponding to the full-frame aperture F-number operation ring is selected.

Next, the optical information table is selected based on the selected detected value table, the current optical unit 2009, and information on whether the aperture information requested by the image pickup apparatus 102 is the F-number or T-number. More specifically, assume that a detected value table corresponding to a full-frame aperture F-number operation ring is selected, a super-35 optical unit is currently attached, and a request for the T-number is received from the image pickup apparatus 102. Then, the optical information table for the T-number illustrated in FIG. 19G is selected in a case where the super-35 optical unit is attached, which corresponds to the full-frame aperture F-number operation ring.

A description will now be given of calculation processing of aperture optical information by the calculation unit 2007. The calculation processing of the aperture optical information by the calculation unit 2007 similar to the calculation processing in the first embodiment. As a specific example, a description will be given of a case that selects the detected value table corresponding to the full-frame aperture F-number operation ring and the optical information table for the T-number where the super-35 optical unit is attached, which corresponds to the full-frame aperture F-number operation ring. In this case, the detected value table stores detected values at index positions on the full-frame aperture F-number operation ring. On the other hand, the current optical unit is a super-35 optical unit, and there is a discrepancy between the selected detected value table and the current optical unit. The image pickup apparatus 102 requests information on the T-number, and there is a discrepancy between the detected value table and the request from the image pickup apparatus 102.

Accordingly, the optical information table for the T-number is selected in a case where the super-35 optical unit is attached, which corresponds to the full-frame F-number operation ring. This configuration can absorb the discrepancy between the selected detected value table and the current optical unit, and the discrepancy the detected value table and the request from the image pickup apparatus 102. That is, the optical information table for the T-number can be generated in a case where the super-35 optical unit is attached from the detected value table corresponding to the full-frame aperture F-number operation ring.

As described above, this embodiment can perform adjustment processing according to the aperture operation ring attached during adjustment, properly use the adjustment value, and calculate optical information according to the current optical unit 2009 and the request from the image pickup apparatus 102.

### Third Variation

In this embodiment, each of the four types of operation rings has a detected value table for the diaphragm 1001i. For example, in a case where the index line positions match, although the full-frame aperture F-number operation ring and the super-35 aperture F-number operation ring have different index values, the detected value table may be shared so as to reduce the number of storable tables. This configuration corresponds to a case where a difference in F-number along with the replacement of the optical unit 2009 is one stage. While the optical unit detector 2010 in this embodiment can automatically detect the optical unit, the disclosure is not limited to this example. For example, the optical unit may be detected by a setting switch structured on a substrate, or by setting with a configuration similar to that of the adjustment execution unit.

### OTHER EMBODIMENTS

Embodiment(s) of the disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read-only memory (ROM), a storage of distributed computing systems, an optical disc (such as a compact disc (CD), digital versatile disc (DVD), or Blu-ray Disc (BD)™), a flash memory device, a memory card, and the like.

The lens apparatus according to each embodiment can select a proper adjustment value for each of a plurality of replaceable operation rings and can generate position information with high accuracy. Thus, for example, each embodiment can provide a lens apparatus, a control method of the lens apparatus, and a storage medium, each of which is beneficial in terms of the accuracy of position information acquired by the position detector at the index on the operating ring.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-062553, filed on Apr. 4, 2022, which is hereby incorporated by reference herein in its entirety.

What is claimed is:

1. A lens apparatus in which a first operation unit and a second operation unit are replaceable with each other, the lens apparatus comprising:
a member movable by an operation of the first operation unit or the second operation unit;
a detector configured to detect a position of the member;
a memory configured to store a plurality of first detected values each of which is output from the detector for a plurality of indices of the first operation unit, and a plurality of second detected values each of which is output from the detector for a plurality of indices of the second operation unit; and
a processor configured to function as:
an acquiring unit configured to acquire characteristic of the lens apparatus based on the position of the member; and
a specifying unit configured to specify one of the first operation unit and the second operation unit to be used,
wherein the acquiring unit acquires the characteristic at least based on the plurality of first detected values in a case where the specifying unit specifies the first operation unit, and the acquiring unit acquires the characteristic at least based on the plurality of second detected values in a case where the specifying unit specifies the second operation unit.

2. The lens apparatus according to claim 1, wherein an arrangement of the plurality of indices of the first operation unit is different from that of the plurality of indices of the second operation unit.

3. The lens apparatus according to claim 1, wherein the first operation unit includes a first ring, the second operation unit includes a second ring, and the first ring and the second ring are replaceable with each other.

4. The lens apparatus according to claim 1, further comprising an identifying unit configured to identify the first operation unit and the second operation unit,
wherein the specifying unit specifies one of the first operation unit and the second operation unit based on an output from the identifying unit.

5. The lens apparatus according to claim 1, wherein the memory stores information indicating newer one of the plurality of first detected values and the plurality of second detected values, and
wherein the specifying unit specifies one of the first operation unit and the second operation unit based on the information.

6. The lens apparatus according to claim 1, wherein a unit of a characteristic for the plurality of indices of the first operation unit and that for the plurality of indices of the second operation unit are different from each other.

7. The lens apparatus according to claim 1, wherein a first optical unit and a second optical unit are replaceable with each other, the plurality of indices of the first operation unit correspond to the first optical unit, and the plurality of indices of the second operation unit correspond to the second optical unit.

8. The lens apparatus according to claim 6, wherein a first optical unit and a second optical unit are replaceable with each other, the plurality of indices of the first operation unit correspond to the first optical unit, and the plurality of indices of the second operation unit correspond to the second optical unit.

9. The lens apparatus according to claim 7,
wherein the processor further functions as an identifying unit configured to identify the first operation unit and the second operation unit, and
wherein the specifying unit specifies one of the first operation unit and the second operation unit based on an output from the identifying unit.

10. The lens apparatus according to claim 1, wherein at least one of the plurality of first detected values and the plurality of second detected values is normalized.

11. The lens apparatus according to claim 10, wherein at least one of the plurality of first detected values and the plurality of second detected values indicates a ratio of a moving amount of the member from one end of a moving range of the member to the moving range.

12. The lens apparatus according to claim 1, wherein the memory stores the characteristic for each of the plurality of indices of the first operation unit and the plurality of indices of the second operation unit.

13. The lens apparatus according to claim 6, wherein the memory stores the characteristic for each of the plurality of indices of the first operation unit and the plurality of indices of the second operation unit.

14. The lens apparatus according to claim 7, wherein the memory stores the characteristic for each of the plurality of indices of the first operation unit and the plurality of indices of the second operation unit.

15. The lens apparatus according to claim 1, wherein the memory stores the characteristic according to a ratio of a moving amount of the member from one end of a moving range of the member to the moving range.

16. The lens apparatus according to claim 6, wherein the memory stores the characteristic according to a ratio of the moving amount of the member from one end of a moving range of the member to the moving range.

17. The lens apparatus according to claim 7, wherein the memory stores the characteristic according to a ratio of a moving amount of the member from one end of a moving range of the member to the moving range.

18. A method of a lens apparatus in which a first operation unit and a second operation unit are replaceable with each other, each of which is configured to move a member, the method comprising:
specifying one of the first operation unit and the second operation unit to be used; and
acquiring a characteristic of the lens apparatus based on a plurality of first detected values each of which is output for at least a plurality of indices of the first operation unit by a detector configured to detect a position of the member in a case where the specifying specifies the first operation unit, and based on a plurality of second detected values each of which is output for at least a plurality of indices of the second operation unit by the detector in a case where the specifying specifies the second operation unit.

19. A non-transitory computer-readable storage medium storing a program that causes a computer to execute a method of a lens apparatus in which a first operation unit and a second operation unit are replaceable with each other, each of which is configured to move a member, the method comprising:
specifying one of the first operation unit and the second operation unit to be used; and
acquiring a characteristic of the lens apparatus based on a plurality of first detected values each of which is output for at least a plurality of indices of the first operation unit by a detector configured to detect a position of the member in a case where the specifying specifies the first operation unit, and based on a plurality of second detected values each of which is output for at least a plurality of indices of the second operation unit by the detector in a case where the specifying specifies the second operation unit.
